(19) United States
(12) Patent Application Publication
(10) Pub. No.: US 2002/0109323 A1
(43) Pub. Date: Aug. 15, 2002

(54) Scooter with shock absorber

(76) Inventor: Jonathon Paul Darnell, Sydney (AU)

Correspondence Address: RABIN & CHAMPAGNE, PC, 1101 14TH STREET, NW, SUITE 500, WASHINGTON, DC, 20005, US

(21) Appl. No.: 09/781,190

(22) Filed: Feb. 13, 2001

(51) Int. Cl. B62M 1/00

(52) U.S. Cl. 280/87.041

(57) ABSTRACT

A collapsible scooter comprises two arcuate members welded to the handlebar having two first holes at the other ends and two second holes adjacent the handlebar; a shock absorber having a front end secured between the first holes of the arcuate members; a connection member including two first holes at the front ends with the second holes of the arcuate members pivotably secured therebetween, a transverse section secured to the footboard, a slot in the transverse section, two second holes through the sides of the slot, and two third holes at the rear ends; and an activation member including two threaded holes, a first pin having a threaded head passed through the second holes of the connection member and the rear end of the shock absorber received in the slot to be secured in one threaded hole, a second pin having a threaded head passed through one of the third holes to be secured in the other threaded hole, and a spring pit on the second pin. The activation member is operable to disengage the first pin from the shock absorber prior to pivoting the footboard and the connection member toward the handlebar about the second holes of the arcuate members.

### FIELD OF THE INVENTION

The present invention relates to scooters and more particularly to a scooter with shock absorber.

### BACKGROUND OF THE INVENTION

Scooters are popular in recent years due to portability (i.e., collapsible) and inexpensive. One of such scooters is shown in FIG. 1 and substantially consists of a low, narrow footboard B with a wheel at each end, a raised handlebar A for steering, a seat D welded on the top front portion of footboard B, an oblique member C having one end welded to a base tube A1 at the lower portion of handlebar A and the other end releasably secured to a pair of opposite holes D1 and a pair of arcuate grooves D2 of the seat D by bolt E and screw F respectively. Thus, the scooter may be collapsed by unfastening and removing screw F from scooter prior to collapsing handlebar A to footboard B about bolt E. The assembly of scooter is simply a reverse procedure of above. However, the previous design suffered from a disadvantage, i.e., there is no provision of shock absorber for lessening the force of shocks and jarring. As understood that such scooter may pose difficulty to the rider while in rolling motion, especially when wheels encounter an irregularity (e.g., crack, pebble) on the ground. Thus improvements exist.

### SUMMARY OF THE INVENTION

It is an object of the present invention to provide a collapsible scooter comprising a footboard; a raised handlebar including a lower base tube; a pair of arcuate members having one ends welded to the base tube, a pair of opposite first holes at the other ends, and a pair of opposite second holes adjacent the base tube; a shock absorber having a rear end and a front end secured between the first holes of the arcuate members; a substantially H-shaped connection member including a pair of narrow front ends, a pair of first holes at the front ends with the second holes of the arcuate members pivotably secured therebetween, a transverse section secured to the footboard, a slot in the transverse section, a pair of opposite second holes through the sides of the slot, and a pair of opposite third holes at the rear ends; and an activation member including a pair of threaded holes a first pin having a threaded head passed through the second holes of the connection member and the rear end of the shock absorber received in the slot to be secured in one of the threaded holes, a second pin having a threaded head passed through one of the third holes to be secured in the other threaded hole, and a spring put on the shank of the second pin; wherein the activation member is operable to pull outwardly to disengage the first pin and the rear end of the shock absorber prior to pivoting the footboard and the coupled connection member toward the handlebar about the second holes of the arcuate members. By providing the shock absorber, a lessening of the force of shocks and jarring is effected, resulting in a more comfortable operation to the rider.

The above and other objects, features and advantages of the present invention will become apparent from the following detailed description taken with the accompanying drawings.

### BRIEF DESCRIPTION OF THE DRAWINGS

FIG. 1 is a perspective view of a conventional scooter without the provision of shock absorber;

FIG. 2 is an exploded view of a scooter with shock absorber according to the invention;

FIG. 3 is a perspective view of the assembled scooter shown in FIG. 2;

FIG. 4 is a partial side plan view in part section of FIG. 3 scooter;

FIG. 4A is a partial bottom plan view in part section of FIG. 3 scooter;

FIG. 5 is a partial side plan view in part section of the collapsed scooter shown in FIG. 3; and

FIG. 5A is a partial bottom plan view in part section of FIG. 5 scooter.

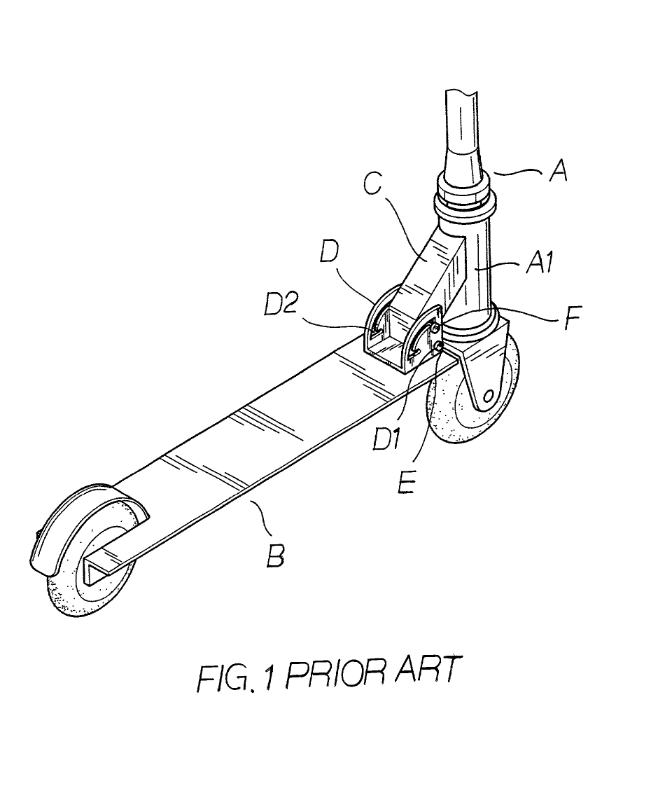

### DETAILED DESCRIPTION OF TIE PREFERRED EMBODIMENTS

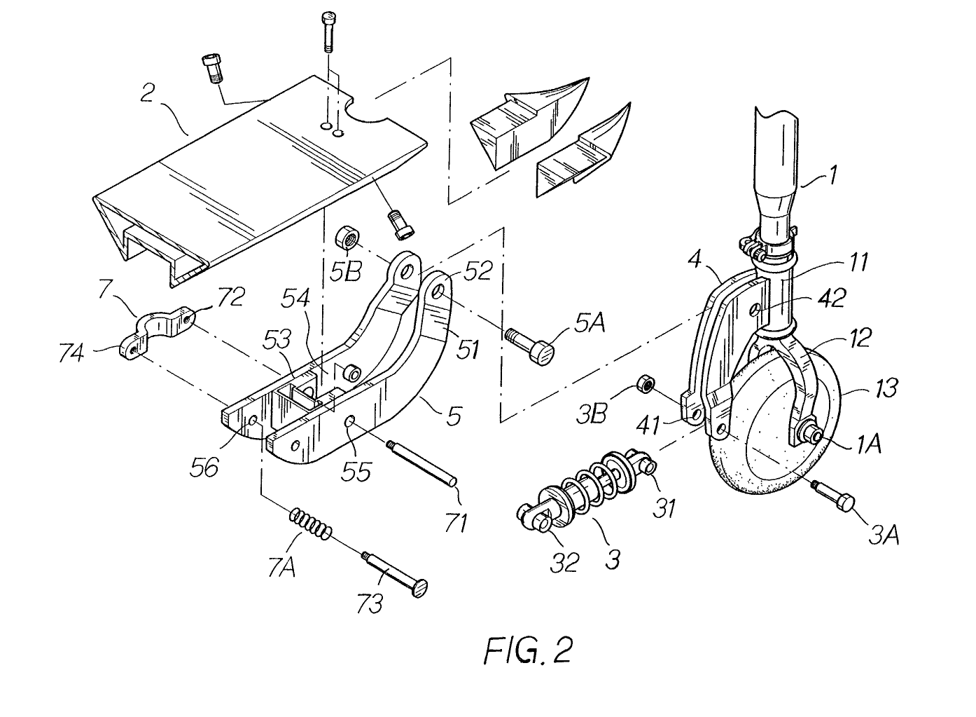

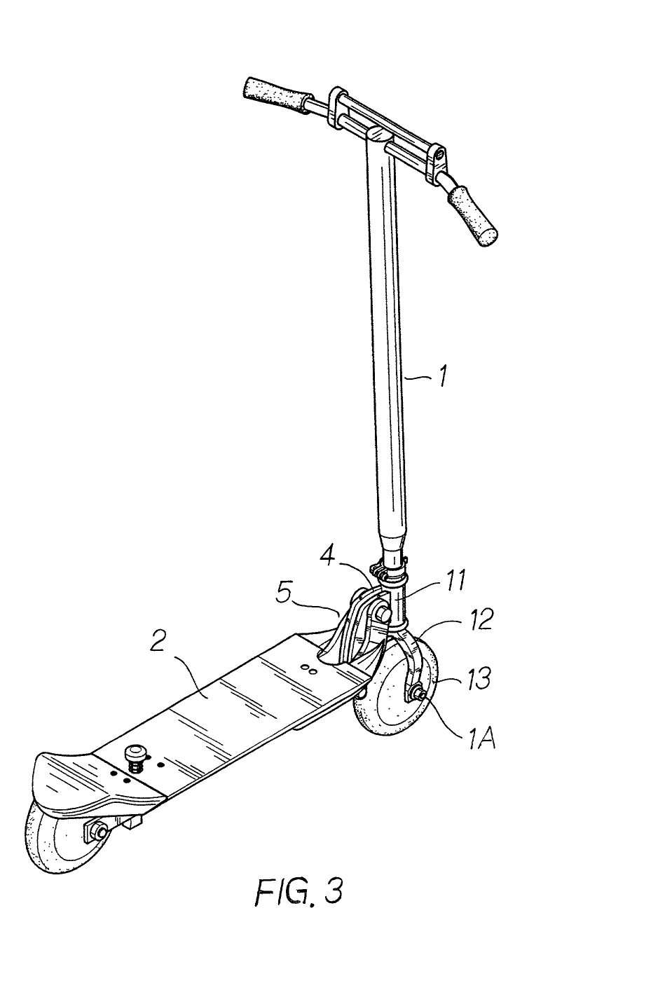

Referring to FIGS. 2 and 3, there is shown a scooter constructed in accordance with the invention. The scooter comprises a low, narrow footboard 2; a raised handlebar 1 including a lower base tube 11 and a fork 12 with a front wheel 13 rotatably mounted therebetween by driving a pin 1A through the ends of fork 12 and the hub of the front wheel 13; a pair of arcuate members 4 having one ends welded to base tube 11, a pair of opposite holes 41 at the other ends, and a pair of opposite holes 42 adjacent base tube 11; a shock absorber 3 (e.g., spring-like member) having a front end 31 secured between the holes 41 by a bolt 3A and a nut 3B combination, a substantially H-shaped connection member 5 including a pair of narrow front ends 51, a pair of holes 52 at the front ends 51 with the holes 42 pivotably secured therebetween by a bolt 5A and a nut 5B combination, a transverse section 53 threadedly secured to the footboard 2, a slot 54 in the transverse section 53, a pair of opposite holes 55 through the sides of slot 54, and a pair of opposite holes 56 at the rear ends; and an activation member 7 including a pair of threaded holes 72 and 74, a pin 71 having a threaded head passed through holes 55 and the rear end 32 of the shock absorber 3 received in slot 54 to be secured in the threaded hole 72, a pin 73 having a threaded head passed through hole 56 to be secured in the threaded hole 74, and a helical spring 7A put on the shank of pin 73.

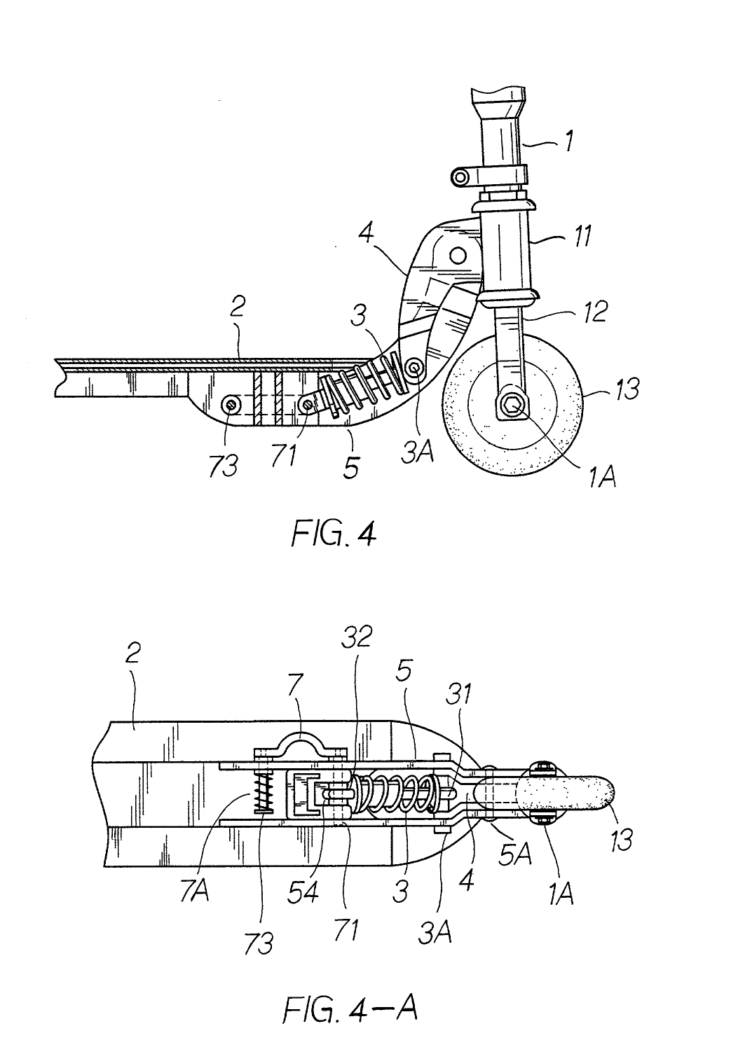

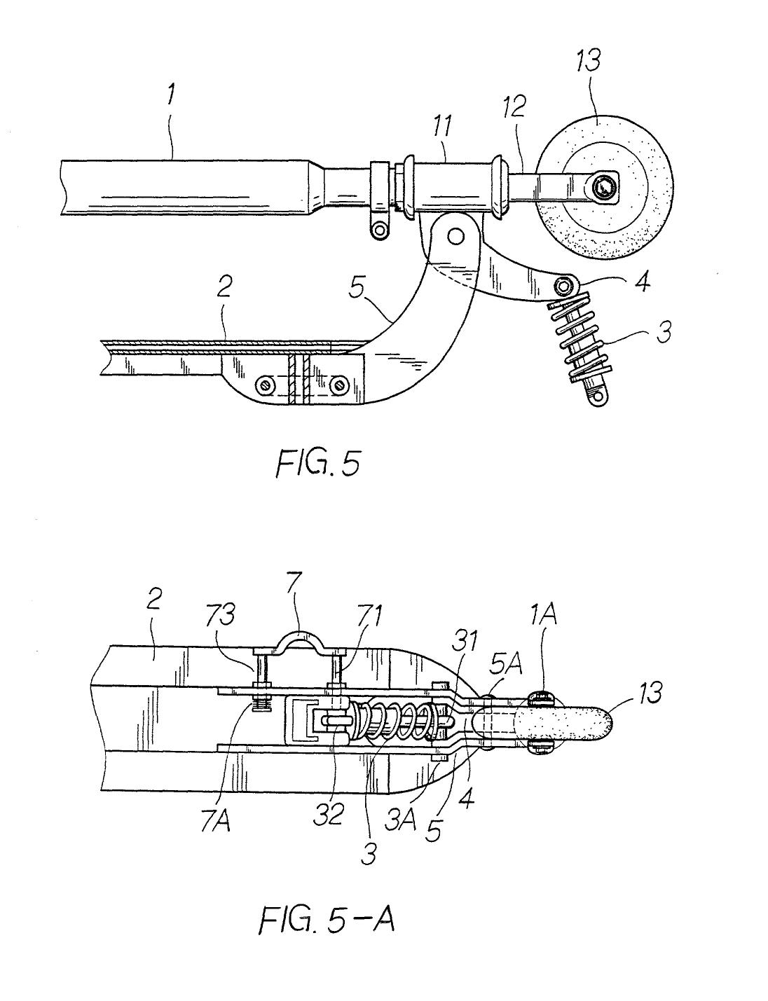

Referring to FIGS. 4 and 4A, a partial view of the assembled scooter is shown. By providing the shock absorber 3, a lessening of the force of shocks and jarring is effected, resulting in a more comfortable operation to the rider. Referring to FIGS. 5 and 5A, the collapsing of scooter will now be described in detail. First pull the activation member 7 outwardly until pin 17 and the rear end 32 of shock absorber 3 are disengaged. Then pivot footboard 2 and the coupled connection member 5 toward handlebar 1 about bolt 5A until stopped. The collapsed scooter is advantageous for storage and transportation.

While the invention has been described by means of specific embodiments, numerous modifications and variations could be made thereto by those skilled in the art without departing from the scope and spirit of the invention set forth in the claims.

What is claimed is:

1. A collapsible scooter comprising:
a footboard;
a raised handlebar including a lower base tube;
a pair of arcuate members having one ends welded to said base tube, a pair of opposite first holes at said other ends, and a pair of opposite second holes adjacent said base tube;
a shock absorber having a rear end and a front end secured between said first holes of said arcuate members;
a substantially H-shaped connection member including a pair of narrow front ends, a pair of first holes at said front ends with said second holes of said arcuate members pivotably secured therebetween, a transverse section secured to said footboard, a slot in said transverse section, a pair of opposite second holes through said sides of said slot, and a pair of opposite third holes at said rear ends; and
an activation member including a pair of threaded holes a first pin having a threaded head passed through said second holes of said connection member and said rear end of said shock absorber received in said slot to be secured in one of said threaded holes, a second pin having a threaded head passed through one of said third holes to be secured in said other threaded hole, and a spring put on said shank of said second pin;
wherein said activation member is operable to pull outwardly to disengage said first pin and said rear end of said shock absorber prior to pivoting said footboard and said coupled connection member toward said handlebar about said second holes of said arcuate members.
